(19) United States
(12) Patent Application Publication
(10) Pub. No.: US 2009/0122940 A1
(43) Pub. Date: May 14, 2009

(54) LOW TEMPERATURE FUSION

(76) Inventor: Ben R. Breed, Dripping Springs, TX (US)

Correspondence Address: FULBRIGHT & JAWORSKI L.L.P., 600 CONGRESS AVE., SUITE 2400, AUSTIN, TX, 78701, US

(21) Appl. No.: 11/909,054

(22) PCT Filed: Mar. 17, 2006
(86) PCT No.: PCT/US06/10003

§ 371 Date: Jun. 23, 2008

Related U.S. Application Data
(60) Provisional application No. 60/662,984, filed on Mar. 18, 2005.
(60) Provisional application No. 60/687,713, filed on Jun. 6, 2005.

(51) Int. Cl. G21B 3/00

(52) U.S. Cl. 376/100; 976/DIG. 1

(57) ABSTRACT

Methods for low-temperature fusion are disclosed. In one embodiment, a symmetrical crystal lattice including a plurality of deuterons either absorbed or embedded in a heavy-electron material is selected. The method provides alternatives for initiating a vibration mode involving the deuterons on the crystal lattice that induces them to converge. The oscillating convergence of the deuterons is enhanced by the charge screening effect of electrons. The electron screening effect is in turn enhanced by the high effective-mass associated with the selected materials. The vibration modes are excited, for example, by applying an electrical stress, a uniform magnetic field, mechanical stress, non-uniform stress, acoustic waves, the de Haas van Alphen effect, electrical resistivity, infrared optical radiation, Raman scattering, or any combination thereof to the crystal lattice.

This patent application claims priority to, and incorporates by reference in its entirety, U.S. Provisional Patent Application Ser. No. 60/662,984 filed on Mar. 18, 2005 and U.S. Provisional Patent Application Ser. No. 60/687,713 filed on Jun. 6, 2005.

### BACKGROUND OF THE INVENTION

1. Field of the Invention

The present disclosure relates to techniques for nuclear fusion. More particularly, the present disclosure involves techniques that are beneficial for achieving low-temperature fusion by initiating vibration modes enhanced by electron screening on the crystal lattice of a heavy-electron material, such as Palladium metal with embedded, i.e., absorbed deuterons.

2. Description of Related Art

Nuclear fusion is the energy-producing process exhibited in the sun and stars. At temperatures ranging from ten to fifteen million degrees Celsius, hydrogen is converted to helium, which expels energy in the form of light and heat. Other fusion mechanisms, such as muon induced fusions, have been produced and can be performed at low temperatures. Muon, a particle similar to the electron but having a mass 207 times larger, when substituted for an electron in a hydrogen molecule, causes the hydrogen nuclei to become closer to each other by a factor of 200. The result is a much increased rate at which the nuclei fuse as compared to a normal hydrogen molecule. However, the measured mean lifetime of a muon is approximately 2.2 microseconds, which is too short to produce enough fusions for practical applications.

While the muon induced fusion does not provide a practical solution for energy production, it demonstrates that the existence of low temperature fusion is possible. For example, Koonin and Nauenberg (1989) give details showing how providing electrons with extra mass increases the rate of fusion in the nuclei of a hydrogen molecule. An electron with five times as much mass can possibly generate fusions at the level reported by Jones et al. (1989), where a mass ten times heavier might generate fusions at a rate in line with the original reports by Fleischmann, Pons and Hawkins (1989).

What would be needed to induce low temperature fusion without muons is an electron that is about 200 times heaver than normal. No such electron exists but the present disclosure shows how the phenomenon of effective-mass may be used instead. This is contrary to certain earlier claims in the fusion community. Due to at least some acceptance of the utility of the effective-mass concept in low temperature fusion, and because of the absence of expected nuclear radiations in low temperature fusion experiments, many previous attempts to explain low temperature fusion have failed. Also, there has apparently been a lack of reproducibility of some experimental claims.

These shortcomings are not intended to be exhaustive, but rather are among many that tend to impair the presumed effectiveness and practicality of previously known low temperature fusion techniques. These problems are sufficient to demonstrate that a significant need exists for the techniques described and claimed here. The absence of expected nuclear radiations is explained here by means of a different but very feasible nuclear reaction. It is also demonstrated that making use of the concept of effective-mass greatly enhances the deuteron fusion process by screening the repulsion of the deuterons' positive charges allowing the deuterons to come close enough together fuse more rapidly.

### SUMMARY OF THE INVENTION

The present disclosure provides a method that produces low-temperature fusion. A crystal lattice including a plurality of a heavy-electron material and embedded, i.e., absorbed deuterons is selected. Next, the method provides a step for initiating a planar lattice vibration mode that induces the deuterons to converge toward one another, thus creating improved conditions for their fusion. The convergence of the deuterons is greatly enhanced by screening using electrons. The disclosure uses the natural tendency of electrons in a heavy electron material to bunch near positive charges. The step of initiating the planar vibration mode can include, but is not limited to the application of electrical stress, a uniform magnetic field, mechanical stress, non-uniform stress, acoustic waves, the de Haas-van Alphen effect, the Shubikov-de Haas effect, electrical resistivity, infrared optical radiation, Raman scattering, or any combination thereof.

The heavy-electron material can be, but is not limited to palladium, platinum, nickel, cobalt, niobium, tantalum, vanadium, titanium, tungsten, yttrium, and zirconium atoms. These materials offer methods for the primary embodiment. In each embodiment, the crystal lattice includes embedded nuclei of hydrogen atoms, protons, deuterons, or tritons. In the description that follows, all of these hydrogen nuclei will be referred to as deuterons.

In an alternate embodiment, the heavy-electron material can be CeCu₂Si₂, UBe₁₃, UPt₃, URu₂Si₂, UPd₂Al₃, UNi₂Al₃, CeCu₂Ge₂, CeRh₂Si₂, CePd₂Si₂, CeIn₃, and other similar materials, rather than one of the primary metals, palladium, platinum, nickel, cobalt, niobium, tantalum, vanadium, titanium, tungsten, yttrium, and zirconium. These types of materials have never been considered as nuclear fusion materials or been embedded with deuterons, prior to this disclosure. Alternatively, in another embodiment, high temperature superconducting materials are substituted for one of the primary metals. These include the doped lanthanide copper oxides, the yttrium-barium-copper oxides, those with the generic composition RBa₂Cu₃O₇₋ₓ, where R stands for yttrium or one of the lanthanide rare earth elements or many other elements in the copper oxide family. This embodiment discusses that fusion of deuterons may be expected in any of these heavy electron systems if they contain absorbed deuterons.

The terms “a” and “an” are defined as one or more unless this disclosure explicitly requires otherwise.

The term “substantially,” “about,” and its variations are defined as being largely but not necessarily wholly what is specified as understood by one of ordinary skill in the art, and in one-non and in one non-limiting embodiment the substantially refers to ranges within 10%, preferably within 5%, more preferably within 1%, and most preferably within 0.5% of what is specified.

The term “coupled” is defined as connected, although not necessarily directly, and not necessarily mechanically.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

Other features and associated advantages will become apparent to those of ordinary skill in the art with reference to the following detailed description of example embodiments in connection with the drawings described below.

### BRIEF DESCRIPTION OF THE DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 shows a two-dimensional arrangement of palladium atoms and deuterons in a planar configuration that may occur when most of the 4-d transition metals are highly doped with absorbed deuterons, in accordance with embodiments of the disclosure. Palladium is used here as an example of metals that have been used in prior claims of successful low temperature fusion experiments. The planar configurations of FIG. 1 are similar to the arrangements of copper and oxygen atoms in planes occurring in copper oxide high temperature superconductors. For example, for a copper-oxygen configuration, the copper atoms would occupy the locations of the palladium shown here and the oxygen atoms would occupy the locations of the deuterons. The similarity implies that the configuration is common to a complete class of heavy electron (high effective-mass) materials. Subsequent figures show how these planar arrangements appear in three types of crystalline unit cells.

FIG. 2A shows an atomic arrangement of deuterons in a body centered cubic (bcc) lattice, where the deuterons may be seen to be residing on planes. These are planes on which convergence of the deuterons (shown in FIG. 4) may be induced, in accordance with embodiments of the disclosure.

FIG. 2B shows an atomic arrangement of deuterons in a face centered cubic (fcc) lattice, where the deuterons reside on planes on which convergence of the deuterons may be induced, as described for FIG. 2A above, in accordance with embodiments of the disclosure. The convergence is enhanced by the screening effects of the high effective-mass of the electrons in the materials selected in accordance with embodiments of the disclosure.

FIG. 3A shows an octahedron enveloping a deuteron indicating an arrangement in which deuterons have octahedral coordination and, in one embodiment, do not reside on a plane, but rather in a configuration in which convergence may be induced toward the center of a tetrahedron, in accordance with embodiments of the disclosure.

FIG. 3B shows a tetrahedron with a deuteron on each vertex, the center of which is the locus of convergence of the deuterons in the case of metals in which deuterons have octahedral coordination, as described in FIG. 3a above, in accordance with embodiments of the disclosure.

FIG. 4 shows a two-dimensional lattice excitation or motion with deuterons converging toward one another as a part of general lattice vibration modes, with the arrows being reversed after a 180 degree phase change, in accordance with embodiments of the disclosure.

FIGS. 5A-5C show different experimental system configurations, in accordance with embodiments of the disclosure.

FIG. 6 shows results of experiments, in accordance with embodiments of the disclosure.

FIG. 7 show magnetic field used in an experimental setup, in accordance with embodiments of the disclosure.

### DESCRIPTION OF ILLUSTRATIVE EMBODIMENTS

The disclosure and the various features and advantageous details are explained more fully with reference to the nonlimiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only and not by way of limitation. Various substitutions, modifications, additions, and/or rearrangements within the spirit and/or scope of the underlying inventive concept will become apparent to those skilled in the art from this disclosure.

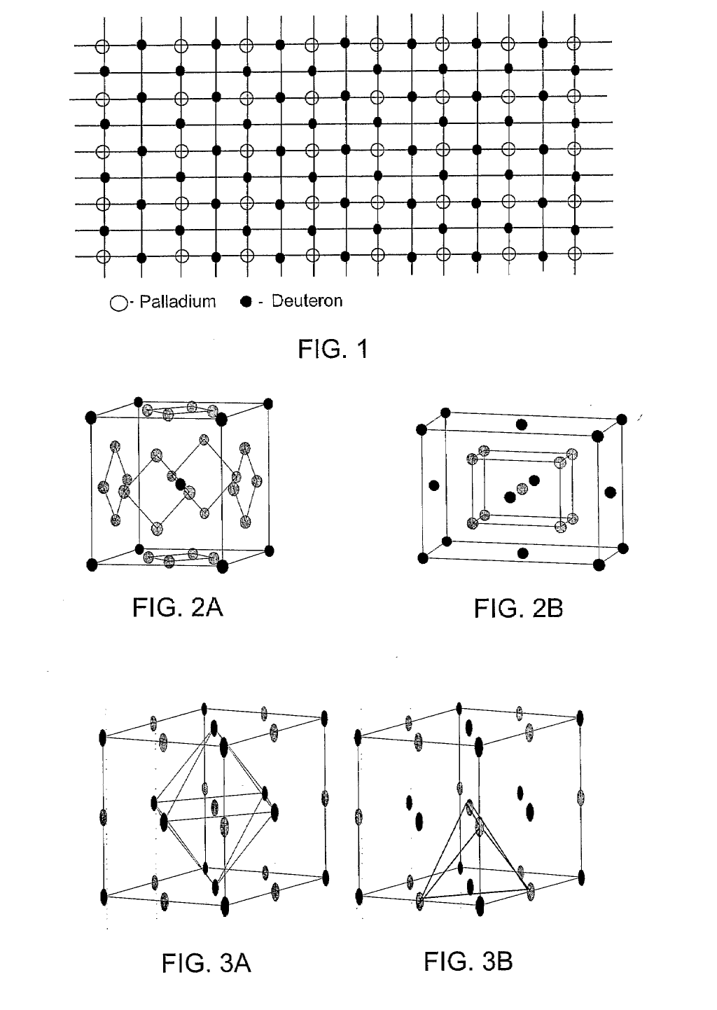

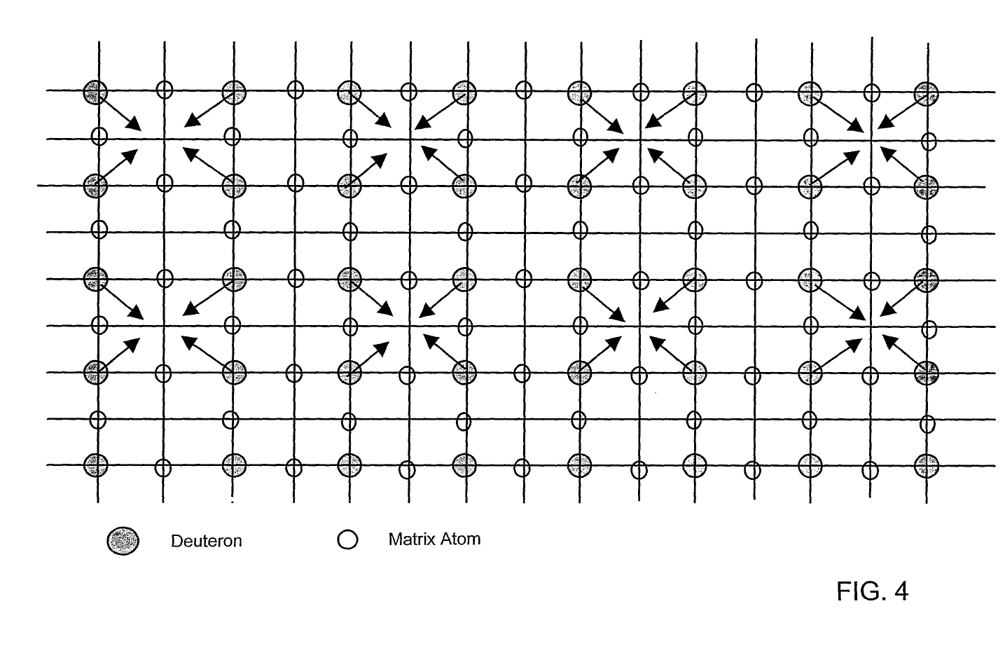

To describe the embodiment that induces the fusion of deuterons, it is best to describe the physical phenomena whose application is part of the embodiment. One of these phenomena is that of heavy electrons (electrons with a high effective-mass). In one embodiment, the selected materials may inherently include heavy electrons, and their heavy nature implies a high degree of localizability of the electrons. This allows a highly localized group of negatively charged electrons to reside in the vicinity of a set of converging deuterons, effectively screening the deuterons having positive charges. Repulsion of the positive charges would otherwise hamper the deuterons' convergence. Perfect screening would allow the deuterons to come arbitrarily close. Another phenomenon applied as an embodiment is the geometry assumed by the deuterons in the selected materials. In the bcc and hcp lattices and in very heavily deuteron doped fcc lattices, the deuterons may be said to reside in three orthogonal planes, as shown in FIG. 1. Planar vibrations may be induced in one of the layered sets of parallel planes, in which four deuterons tend to converge (shown in FIG. 4) aided by an electron screening process.

Materials used in research for low temperature fusion typically involve heavy electrons. They are sometimes referred to as heavy fermion materials. For example, materials with very high electronic effective-mass as tabulated by Kittel (1961) include palladium, platinum, nickel, and cobalt, all of which been considered for low temperature fusion. Today's scientific interest in heavy electron materials is more due to the existence in these materials of high-temperature superconductivity, rather than their applicability to low temperature fusion. The discovery of superconductivity in hydrogen doped palladium indicates that this material has properties similar to the high temperature superconductors. The critical temperature of a doped palladium superconductor increases with hydrogen loading, demonstrating that it is a member of this heavy electron class of composite metals. Along with having superconducting phases these materials often exhibit ferromagnetic and anti-ferromagnetic phases (Frans, 2004 and Shen, 2005).

The concept of effective-mass for electrons in a metal is a solid state physics phenomenon and is not equivalent to having real electrons in the metal with a different mass. Koonin and Nauenberg (1989) point out that effective-mass is a lattice-wide (whole crystal) collective phenomenon and does not apply to the dynamics of individual electrons. This statement is correct for the classical effective-mass concept, however, omits the fact that individual electrons may be replaced with heavy highly correlated pseudo-particles with desirable properties, as described below. These materials effectively have a high mass caused by their many-body interactions, where the electrons corresponding to pseudo-particle energy peaks may be broad in their wave number.

The effective-mass concept possesses a characteristic in common with an individual particle mass, and the existence of this mutual property makes a large difference as described herein. In atomic units, mass is normally expressed as a multiple of a reciprocal length. An example of this is the Bohr radius being expressed as a reciprocal of the electronic mass (Herzberg, 1945). Using special relativity, it can be seen the mass-length relation is a result of quantum mechanical canonical commutation relations. The higher the mass of a particle (or quasi-particle), the greater the chances are to localize it. In the following paragraphs, the mass-length relationship will be used to point to the fact that high effective-masses in a metal can imply high localization of electrons on atomic lattice sites. This in turn will be used to argue that the effect of the heavy-electrons in a palladium lattice, for example, doped with deuterons is to provide a much more effective screening effect between the deuterons than would be possible in a metal with a lower electronic effective-mass.

Particles, such as electrons, may acquire an effective-mass through mutual interactions in a many-body system (Kittel, 1961; Abrikosov et al., 1975; and Slater, 1972). For example, c-onsider a many-body system with a Hamiltonian written in the following form:

H=H₀+H₁ Eq. 1

where H₀ and H₁ are the free particle and interaction Hamiltonians, respectively. If the free particle Green's function G₀ (based on H₀) is known, the many-body Green's function may, in principle, be found by solving the Dyson equation

G=G₀+G₀ΣG Eq.2

in which Σ=Σ₁+Σ₂+Σ₃+ . . . is known as the “irreducible self-energy part” or “the mass operator” (Abrikosov et al., 1975 and Kadanoff et al., 1962). This expression is known for the contributions to the mass of a quasi-particle generated in the system due to inter-particle interactions. The expression for Σ is a sum of progressively larger (but weaker) stages of the interaction. After “mass renormalization,” the Green's function is commonly expressed in the frequency-wave number (k, ω) domain as

G(k,ω)=[ω−eₖ−Σ(k,ω)]⁻¹ Eq. 3

in which Σ is in general a complex number, and eₖ is the energy in a band at wave number k (Abrikosov et al., 1975; Kadanoff et al., 1962; and Rickayzen, 1980). The corresponding spectral function is

$$A ( k , - i ω ) ≡ - \frac{1}{π} Im ( G ( k , ω ) ) = - \frac{1}{π} [ \frac{λ}{{( ω - {e}_{k} - {Σ}_{r} )}^{ 2} + {λ}^{2}} ] , \qquad Eq . 4$$

where Σᵣ=Re(Σ(k,ω)) and λ=Im(Σ(k,ω)) are the real and imaginary parts of Σ, respectively. The spectrum is an approximate Lorentzian density, where λ the imaginary part of Σ controlling the lifetime of the pseudo-particle. If eₖ and k are to be good (stable) quantum numbers, the imaginary part must be small and the particle lifetime long. The real part of Σ is the contribution to the pseudo-particle's effective-mass over that of a single electron, for example, in a single electron tight binding approximation (Kittel, 1961 and Slater, 1972). Since the target crystal lattices are mostly cubic, the spectrum may be treated as being isotropic without loss of significant generality. This greatly simplifies the equations in the following description.

The peak of the spectral function occurs where Eₖ≡ω(k)=eₖ+Σᵣ. For a particular direction in wave number space, the point at which the peak occurs will be denoted k=k₀. For an isotropic environment the effective-mass (Kittel, 1961 and Abrikosov, 1975) evaluated for the pseudo-particle representing the spectral peak, has the definition

$${( {m}^{*} )}^{- 1} ≡ \frac{{\partial }^{2} {E}_{k}}{\partial {k}^{2}} {\vert}_{\begin{matrix}ω = ω ( {k}_{0} ) \\ k = {k}_{0} , {e}_{k} = {e}_{{k}_{0}}\end{matrix}} . \qquad Eq . 5$$

When the expression for the energy is expanded about this peak, the energy becomes

$${E}_{k} = {E}_{{k}_{0}} + \frac{1}{2} {( k - {k}_{0} )}^{2} / {m}^{*} + … \qquad Eq . 6$$

and if this expression is substituted in the spectral function the results are as follows:

$$A ( k , - i ω ) {\vert}_{k \approx {k}_{0}} = - \frac{λ}{π} {\vert [ ( \frac{{( k - {k}_{0} )}^{2}}{2 {m}^{*}} ) + … + i λ ] \vert}^{- 2} , \qquad Eq . 7$$

which is the transfer function of a linear system having a peak whose spectral width is proportional to m* for small λ, which corresponds to an impulse response that is highly peaked spatially with appropriate periodicity and with a spatial width proportional to 1/m*. For a crystal of finite extent, spatial separations and wave numbers can both discrete and the Fourier transforms involved in this derivation are discrete Fourier transforms (DFTs). The Fourier transform of a narrow energy band extends periodically, and is seen to have a width inversely proportional to the band's width.

The above shows that a narrow spectral line corresponds to heavy-electrons or pseudo-particles that, though defined over long ranges, are spatially periodic and may be locally concentrated within any one spatial period if its k₀ is near the zone boundary and if it has a large wave number spread. Unless the pseudo-particle represents a moving charge density wave, the charge will be concentrated on atomic lattice sites to maintain charge equalization. This implies concentration on positive hydrogen nuclei. This is particularly true if the heavy-electronic system conforms to the Hubbard model for which two electrons being confined on a site is a basic part of the model.

The Hubbard model is commonly used to explain heavy-electron systems (Montorsi, 1992 and Rasetti, 1991). The model provides a configuration of atoms with partially filled 4d- or 5d-shells forming a narrow band interacting with atomic states. The narrowness of the d-band implies a high degree of correlation among the electrons. To explain certain behavior, the Hubbard model contrasts this implied delocalized band motion with the effect of a tight-binding model in which d-electrons are allowed to spend a proportionately large amount of time in the vicinity of the lattice sites. For the Hubbard model, the Hamiltonian may be written in the following form:

$$H = - t {\sum }_{i , {i}^{′} , σ} {c}_{i , σ}^{+} {c}_{{i}^{′} , σ} + U {\sum }_{i} {n}_{{i}_{↑}} {n}_{{i}_{↓}} \qquad Eq . 8$$

(Rasetti, 1991). Here the sum over σ is a sum over the up and down spins, c_{i,σ}⁺ is a creation operator for an electron with spin σ at lattice site i, and c_{i′,σ} is the corresponding annihilation operator at site i′. If an electron is created at i and another is annihilated at i′, the electron may have moved from one site to the other. It is generally found that an experimentally verifiable physical model may be achieved when these moving transitions are restricted to adjacent lattice sites. This is called hybridization between neighboring sites. For the second sum over number operators in Eq. 8, n_{i↑} as an example, is the number of electrons with up-spin at site i, etc., where n_{i↑}≡c_{i↑}⁺c_{i↑} and n_{i↓}≡c_{i↓}⁺c_{i↓}. Each of the terms in the second sum corresponds to two electrons interacting at the same site. t and U are coefficients that determine the relative contributions of the two terms. If U is large, the model describes electrons confined to their atoms. If t is large, the model describes the opposite situation where the electrons are free to move. From the point of view of charges concentrated at lattice sites for the purpose of screening deuterons, according to one embodiment of this invention, a large value of U is desirable, but the movement of an electron must also be allowed in order to transfer the charges between the transition metal atoms and the hydrogen nuclei and so-forth.

As has been discussed, palladium and other metals that have been involved in cold fusion claims are members of a class of heavy-electron metals, implying a high degree of localization of the electrons on atomic lattice sites due to their greater mass. This helps to resolve a claim existing in the literature that states that low temperature fusion phenomena are unphysical because there is no conceivable method for producing a coupling between the metal lattice, the electrons, and the embedded hydrogen nuclei. To the contrary, one embodiment of this disclosure is based on just such an interaction. The coupling must have a large enough effect to overcome repulsion between nuclei. The electrons screen the positive charges so that they repel each other less. Further, the screening effect should be large enough accompanied by localizing of charge at lattice sites. This indicates that a high level of screening by this mechanism is available.

Another well known fact about effective-mass is that it can be substituted for the actual mass of an electron in many equations to achieve better agreement with experiment for explaining such phenomena as the electronic heat capacity, Pauli spin susceptibility, Landau diamagnetic susceptibility, and electrical resistance and mobility. This fact may be explained in terms of many-body cooperative phenomena, i.e., correlated actions that may occur crystal-wide that may have the appearance of single, but heavier electrons at each site. The heavy-electrons appear to respond to external forces as if they have increased inertia, and this too, is an important fact since it implies that the heavy-electron has a smaller wavelength in any given energy state than single electrons in a tight binding model.

It is noted that charge concentration on lattice sites as discussed above has recently been directly observed on high temperature superconductor surfaces (Franz, 2004 and Shen, 2005).

### Geometric Structures

In explaining the feasibility of interactions where multiple nuclei participate, it is convenient to describe the crystal geometries that are important to the embodiments of this disclosure. Further, before discussing palladium and the other candidate materials for low temperature fusion, the discussion of results obtained for general heavy-electron materials is reviewed. For example, rare-earth copper-oxides are prominent among the class of heavy-electron materials. In many ways, these materials may be considered layered two-dimensional structures. They appear as a stack of weakly coupled two-dimensional planes of Cu and O atoms, similar to the lattice shown in FIG. 1 which illustrates a palladium-deuteron structure (Montorsi et al, 1992). For example, the open circles in FIG. 1 could represent the copper atoms and the solid circles can represent the oxygen atoms. The two-dimensional configuration depicted is representative of planes existing in all transition metal deuterides and in almost all copper-oxide superconductors. Similar configurations may be seen in transition metal hydride crystals that are embodied in this disclosure, in which deuterons are embedded at sites with tetragonal symmetry. The similarity may be feasible for low temperature fusion to occur for these heave electron materials that may be embedded with deuterons.

The importance of having deuterons occupying lattice sites is that in this situation, the deuterons are generally found to be on any one of three orthogonal planes. In each of these planes, the deuterons form a square planar sub-lattice. The significance of deuterons having octahedral coordination is that they do not form these planes. Normally, at lower concentrations, deuterium atoms occupy octahedral sites in the fcc lattices. The tetragonal sites in these lattices are almost as feasible energetically and become occupied at higher deuteron concentrations (Elasser, 1991 and 1994). Thus at high concentrations, the deuterons may be found to form square planar sub-lattices even in the case of the fcc lattice. Crystal lattices with tetrahedral symmetry are pictured in FIGS. 2A and 2B. FIG. 2A depicts the bcc crystal with the metal atoms in black and the deuterons in the gray shade. FIG. 2B shows the fcc example where the deuterons have a tetrahedral coordination. These unit cells are repeated throughout the lattice. It is not immediately apparent, but in each figure there is a plane with four deuterons on it, and the plane may be extended in each direction. It is also noted that each of these planes is one of three perpendicular planes. Also the deuterons on any one of these planes may be mapped into the locations shown in FIG. 1. For a bcc case (FIG. 2A), atoms of the bcc metal may lie above and below each plane of deuterons. In the fcc case, the metal is mapped alternately below and above each plane. No figure of a hexagonal close packed (hcp) has been presented here, but the same situation applies as may be seen in Wipf (1997). Here again, there are planes of deuterons forming a square planar sub-lattice with each deuteron having tetrahedral coordination in the metallic lattice.

Deuterons placed at sites with octahedral symmetry as in an fcc lattice at lower concentrations may also conform to the layered structure of the high temperature superconductors. This configuration is presented in FIG. 3b, where several independent planar square sub-lattices are shown. In FIG. 3A, an octahedron has been drawn around the metal atom at the center of the body-centered cube, demonstrating an octahedral coordination. The deuterons and metal atoms can have the same octahedral coordination since the metal atoms and deuterons form (symmetrically interlaced) fcc lattices. Rather than having four deuterons converging toward a common point in a plane, the octahedral symmetry offers the possibility of the four deuterons at the vertices of a tetrahedron converging toward the tetrahedron's geometric center, as shown in FIG. 3C.

This last sort of deuteron convergence toward the center of a tetrahedron is similar to that proposed by A. Takahashi (2003) in his electron quasi-particle expansion theory (EQPET). Takahashi theory involves the convergence of deuterons (along with certain electrons) toward the center of the tetrahedrons with convergence being due to “transient Bose-type condensation (TBC) of deuteron cluster at PdDₓ lattice focal points (Takahashi, 2003).” Further differences between EQPET and the proposed mechanisms of this report are found below in the discussion of multiple deuteron interactions.

### A Model for Lattice, Electron, Deuteron Interaction

In FIG. 4, an embodiment of the disclosure is shown. FIG. 4 shows an adaptation of FIG. 1 to indicate movement. In particular, motions of the deuterons have been generally indicated in the planar square lattice. In the square lattice there are four deuterons converging toward a common (vacant) point. At a time corresponding to one half oscillation period later, the deuterons may have reversed directions and converge at opposite points. This motion may be considered to be a part of high wave number lattice excitations that are an integral part of the ambient phonon spectrum of the metal deuteron composite. The wave numbers corresponding to these oscillations are large since their spatial period is on the order of twice the atomic spacing. The wave numbers are therefore on or near a Brillouin zone boundary in the plane. Motions of the lattice host (metal) atoms (transparent circles) are not indicated since they may assume different forms for different lattice normal modes.

In one embodiment, a metal is picked belonging to the heavy-electron class of transition metals with deuterons embedded. The extent of loading of the deuterons is made to be stoichometric, PdDₓ, where x is about 0.5 or greater. An electron model such as the Hubbard model may apply. Electronic charge may be localized to a large extent on the positive ions, the metal ions, and the deuterons. This charge localization may be a result of the heavy-electronic-mass many-body phenomenon. The interaction of the deuterons may be affected and enhanced by this concentrated cloud of negative charge because the negative charge screens the positive charges of the deuterons. The Born-Oppenheimer approximation may apply only in so far as the positive ions may have much greater mass than the electrons, meaning that their displacements are slow variables in the many-body system. The electronic structure, however, may be strongly affected (slaved) by their motions. The closer any number of deuterons is grouped, the greater the mean positive charge in their vicinity and, in response the localized negative charge of the electrons may be greater, generating a synergistic interaction.

The electronic response may be not without inertial effects and offers the possibility of a resonance of sorts in the deuteron motions. A set of deuteron motions tending to a common point, as shown in FIG. 4, may induce electrons to be located in the vicinity and thus, may produce a screening effect such that the lattice vibration force constants for these motions may be greatly reduced. The amount the reduction of the force constants may be highly dependent on the wave number, especially for lattice excitations with wave lengths on the two dimensional Brillouin zone boundaries of the lattice planes that contain the vibrating deuteron modes, as shown in FIG. 4. At these wavelengths, the greatest convergence of deuterons may occur.

Being on the Brillouin zone boundary, these modes may include phase velocities in the plane of a two-dimensional Brillouin zone that are near zero. Alternatively, in another embodiment, lattice vibrations with larger wave lengths may also generate convergence. Considering the use being made here of comparisons to the copper oxides, the two-dimensional, instead of three-dimensional, nature of these lattice excitations, along with their wave number dependence, conforms with experimental observations on the “importance of the momentum anisotropy in determining the complex properties of the cuprates . . . ” (Shen, 2005). The same may be presumed to apply for the hydrides.

The variation of force constants with wave number, along with their dependence on the wave amplitude, may be an indicator of non-linear interactions. A model that fits this type of non-linear wave phenomena, with need for only minor alteration, has already been worked out. For example, the model has been presented by Sulem et al. (1999) as one possible derivation of the non-linear Schrödinger equation (NSE), assuming that the wave equation L(∂ₜ,Δ)u=0 applies, where L is an operator with constant coefficients. For small amplitudes, any non-linear terms may be neglected in which case the solution has a form

u=εψe^{i(kx-ωt)},

where k and ω are related by the dispersion relation L(−iω,k)u=0, and where ε represents a small number. The non-linearity may be introduced by requiring a specific, but alternate, dispersion relation and introducing this dispersion relation in place of the linear one in the form,

ω(i∂ₜ−iΔ)ψe^{(ikx-ωt)}=0 Eq. 9.

For the new dispersion relation the function ψ may be constrained to be modulated in space and time in a specified fashion. After expanding the desired dispersion relation about the linear one, the function ψ may be required to satisfy the (NSE), as follows

$$i \frac{{\partial }_{ψ}}{{\partial }_{τ}} + \frac{1}{{m}^{*}} {∇}^{2} ψ + γ {\vert ψ \vert}^{2} ψ = 0 , \qquad Eq . 10$$

where the electron mass mₑ has been replaced by half the effective-mass, m*/2. Due to the lattice periodicity, both the solution of the NSE and the Hubbard model wave functions are Bloch functions. The parameter γ is proportional to the first order term in the expansion of the non-linear dispersion relation in terms of its dependence on the wave amplitude-squared. This may be useful in the present context. The parameter γ may be made a function of wave number matching the physics expected near the two-dimensional Brillouin zone boundaries as discussed above. γ may correspond to a lowering of the mode energy kω, per phonon, on this boundary (a reciprocal of the electron screening). At room temperature this corresponds to an increase in the occupancy of these deuteron many-body oscillator states.

The embodiments of the disclosure are based on a coupling between the Hubbard model for the electronic motion and the non-linear Schrödinger-type equation describing the lattice interaction. The coupling is evidenced in the two parameters: U of the Hubbard model and γ of the NSE. The concentration of electron pairs depending on U may be influenced by the lattice wave functions-squared and phonon wave number defined by γ. Further, γ defines how the screening effectiveness, depends on the size of U. The possibility of resonance phenomena being induced by this type of coupling is apparent to those with ordinary skill in the art. It is anticipated that mode locking and mode competition phenomena will exist, and these will lead to highly correlated, large amplitude deuteron motions.

An effect known as Peierls instability may occur on a zone boundary when the d-band is not filled and the Fermi level E_{f} falls within the band as described in Peierls (1955). A spatially periodic lattice distortion may occur to induce a lower energy state that occurs for the regular lattice. The distortions produced by the motions indicated in FIG. 4 may have a periodicity twice that of the lattice, and may be viewed as inducing a spatially periodic lattice distortion. This opens the possibility of a time periodic Peierls instability at the frequency of these vibration modes.

When applied in more than one dimension, the NSE does not describe solitary waves (solitons) in general. Instead, the NSE may display some interesting features related to the occurrence of “blow up” and “wave collapse” (Sulem et al., 1999). These phenomena may not be relevant due to the approximations made in the NSE derivation, but it is easy (but unwarranted) to speculate that these phenomena may be associated with bursts of excess energy that have been noted in some experiments.

There can be Nuclear Reactions where Multiple Deuterons Participate, in which there are No Unaccounted By-Products

There are many reasons to expect that low energy fusion involves nuclear reactions of a different kind than those found in a normal nuclear physics experiment. Experiments in nuclear physics normally involve a high energy projectile (perhaps a deuteron) directed onto a stationary target (possibly also a deuteron). Other experiments include pointing two high energy beams at one another such that the particles may be made to interact. In either scenario, the interaction between more than two particles may be improbable. The probability of having more than two particles in the same small volume at the same instant is just too small (unless they are already in a common nucleus). In a metallic, crystalline environment, the situation is completely different. There are always multiple particles in the close proximity with one another. Many-body interactions are common and varied.

What may be missing in the many-body environment are the high energies provided by particle accelerators. However, to compensate for this deficiency, there are electrons present and they may participate in a role similar to that of a catalyst (by screening positive charge). No such catalyst is present in the normal nuclear physics experiment. When multiple free deuterons are brought together, the physics involved is not completely understood, except perhaps in a thermonuclear environment.

The following discussion of fusion products, as being expected but not observed, is based on a fundamental supposition. The reason proton, neutron, and gamma ray by-products are expected in D-D reactions when the released energy is converted to kinetic energy. Thus, there must be something for the helium isotope that is formed in the process to react against in order to conserve momentum. But when four deuterons are brought together, whether all of them are involved in the final reaction product or not, there are many alternative methods of conserving momentum. If the four deuterons form a nucleus with atomic mass of five or six, there must be a nucleon or a gamma ray as one of the by-products because there are no deuterons left to react against. However, those reactions producing a mass of five or six are highly improbable compared to those producing one or two helium nuclei. A helium nucleus (or alpha particle) is one of the most stable, and therefore most probable, nuclei in existence. In the event two helium nuclei are produced they may conserve momentum by reacting one against the other rather than ejecting smaller sized particles. In the event a single helium nucleus is produced, the nucleus may react against the other two deuterons.

In one embodiment, the lack of fusion by-products, in so far as multiple deuterons are involved, is similar to that in Takahashi's EQPET theory (Takahashi, 2003). Other than that, there may not be a need to involve transient the Bose-Einstein condensation of that theory. Instead, the source of screening may be due to the heavy-electron character of the materials involved, along with the non-linear enhancement of the screening effect in a layered structure of deuterons distributed in parallel planes. Enhancement may be due to heavy-electron interaction with very short wavelength phonons that are on or near the edge of the planar Brillouin zone. Also the planar interactions are analogous to the similar interactions in high temperature superconductors. The planes may be formed from deuterons on tetrahedral sites. Similarly, thicker planes are formed by deuterons in octahedral sites.

The interactions discussed herein involve at most four deuterons, and not as many as the eight that may occur in the EQPET theory. Only for PdDₓ lattices, where x is less than or equal to one-half, are the four deuterons expected to converge to the center of a tetrahedron. All reacting deuterons are so-constrained in EQPET. Injecting more than the stoichometric deuteron amount may allow deuterons to be situated on tetrahedral sites, even in fcc lattices, where again, they may participate in the collective planar motions shown in FIG. 4. It should also be emphasized that although four deuterons may be involved, not all of them need be changed in the nuclear reaction. The dominant expected output is a helium nucleus, and for this the utility of other deuterons for momentum conservation may itself be viewed as a type of catalytic phenomenon.

### Experimental Reproducibility and Possible Remedies

The fusion mechanism of this disclosure may include several considerations. In establishing motivation for the fusion mechanism, various analogies have been drawn between crystal planes of deuterons and the copper-oxide planes in high temperature superconductors. The planes are apparent when the crystal structures are viewed from certain perspectives. But the transition metal hydrides have a much greater symmetry than the copper-oxides in that there are three or more sets of planes in their lattices. There is a need to break this symmetry for the desired vibration mode to be established. Interactions in layered sets of a single one of these planes are desirable. Factors expected to influence the establishment of proper symmetry conditions are crystal shape, orientation, a magnetic field, electrical, and thermal fluxes. The remedy for lack of reproducibility of experiments in this area is a proper understanding of the physics and development of any method for setting the two-dimensional process in motion.

The fusion rates for the above-identified processes have not been calculated because many such calculations are available. The most quoted calculations are those presented in Koonin and Nauenberg (1989), where they state, “[a] mass enhancement of m*≈5mₑ would be required to bring the cold fusion rates into the range claimed by ref. 7. An enhancement of m*≈10mₑ is required by the results of ref. 6”. References 6 and 7 are to the papers by Fleischmann, Pons, and Hawkins (1989) and Jones et al. (1989), respectively. The symbol m* used in Koonin and Nauenberg is not the same as the symbol used elsewhere in the present disclosure. Koonin and Nauenberg denotes m* as the mass of a putative electron that is 5 or 10 times the physical electron's mass (similar to the way the muon weighs 207 times as much as the physical electron).

It has been mentioned many times in the literature that a large effective-mass can have no significant effect on screening deuterons to aid in low temperature fusion (Huizenga, 1993). This is supposed to be due to the fact that effective-mass is a long wavelength phenomenon and therefore, cannot be effective at the very short distances that would be required. But, Kittel (1961) notes that palladium has a high effective-mass of 27mₑ, platinum has an effective-mass of m*≈13mₑ, nickel 28mₑ, and many of the transition metals are members of the heavy-electron class. This may purely be a coincidence. It has been shown above, that in actual fact, while heavy electrons are long range phenomena, their effect is periodic and a significant localization effect can occur within a unit-cell. In this sense, a process may have a periodic local effect even if it is itself a long range phenomenon, if the pseudo particle has sufficient bandwidth in wave number space, near a Brillouin boundary. That electron (or charge) concentration actually occurs in heavy electron materials, as discussed herein, has also been demonstrated recently by direct observation (Franz, 2004 and Shen, 2005).

There have been other authors who advocate effective-mass as a contributor to low temperature fusion. For example, Parmenter and Lamb (1990) made calculations based on an electron screening approach using a modified Thomas, Fermi, Mott (TFM) equation. Their effective-mass varied with wave number but in a way opposite to that described above. T. Tajima, et al. (1990) have found a very large screening effect in their candidate process. An interesting result with regard to screening is that of Hora, et al. (1993), who note that the fusion rate changes by five orders of magnitude if the screening factor changes by only a few percent. Hora et al. also note that D-D and D-T fusion reactions are “rather exceptional as the cross sections are up to several barns and the nuclei react at distances 50 or more times the nuclear diameters.” The implication for multiple deuteron interactions of an expanded strong nuclear range is apparent, especially if the deuterons are well screened.

In summary, two major reasons that have been advanced for rejecting the possibility in producing low temperature fusion have been addressed above. These difficulties have impaired the acceptance of previously known explanations. The embodiments of this disclosure have provided a counter-example for each difficulty. It is believed that low temperature fusion is not barred by any basic physics principles.

### EXAMPLES

Specific embodiments of the disclosure will now be further described by the following, nonlimiting examples which will serve to illustrate in some detail various features. The following examples are included to facilitate an understanding of ways in which the disclosure may be practiced. It should be appreciated that the examples which follow represent embodiments discovered to function well in the practice of the disclosure, and thus can be considered to constitute preferred modes for the practice of the disclosure. However, it should be appreciated that many changes can be made in the exemplary embodiments which are disclosed while still obtaining like or similar result without departing from the spirit and scope of the disclosure. Accordingly, the examples should not be construed as limiting the scope of the disclosure.

As noted above, the process of low temperature fusion of hydrogen nuclei may be caused by:
A. the heavy electron (high effective-mass) nature of the selected materials;
B. the consequent concentration of electronic charge on atomic and deuterium lattice sites;
C. the planar nature of the distribution of deuterons absorbed in the selected materials:
D. the interaction of four deuterons situated in one of the planes as shown in FIG. 4 aided by the concentration of electrical charge described in item B;
E. the non-linear interaction of the electronic charge structure with the small wavelength lattice vibrations of the absorbed deuterons, shown in FIG. 4;
F. an increase in the negative electrons' screening of the deuterons' positive charge, aiding in deuteron fusion;
G. the dynamic localization effect that has been noted in super-lattices to aid in the screening effect that is itself enhanced by electron localization as described e.g., Dunlap and Kenkre (1986) or Ghosh, Kuznetsov, and Wilkins (1997); and/or
H. the use of four deuterons converging with a high degree of symmetry in a plane or toward the centers of tetrahedrons, eliminating the need for deuteron pairs to interact in a state of near zero relative angular momentum.

In general, the present disclosure provides a realistic explanation of the low temperature fusion phenomenon, which has been lacking in prior references. The details of the disclosure involve methods of implementing conditions under which the described mechanism is made operative.

The fusion mechanism proposed includes several considerations. In establishing motivation for the fusion mechanism, various analogies have been made between the crystal planes of deuterons in the selected materials and the copper-oxide planes in the high temperature superconductors. The planes of deuterons may become apparent when viewed from certain crystal perspectives. But the transition metal hydrides have a greater symmetry than the copper-oxides, because the planes of deuterons may be any one of a set of three perpendicular planes. There is a need to discount this three-fold symmetry if the vibration mode with deuterons converging in single set of layered parallel planes is to be established.

Factors expected to influence the establishment of proper conditions are crystal shape and orientation, the application of external forces, doping of the materials, magnetic fields, and electrical and thermal fluxes. Finally, there exist heavy-electron (heavy-fermion) materials having themselves the correct symmetry. As additional sources of fusion processes, deuterons may be embedded in one of these crystals for which the symmetry is proper already. This extends the possible materials.

1. In one embodiment, the materials must be made in one of the proper shapes. It has been noted that thin films have been successful, and this may be explained as restricting lattice interactions to the conforming planes in the film. The three-fold symmetry of the material is broken by the lack of the other perpendicular planes. Thus, the embodiment involving deuterons interacting in parallel planes explains this phenomenon. It is noted here that a thin-film, by its nature is two-dimensional, i.e., the thickness of the film is substantially negligible.
2. The same applies to sample surfaces, since any point on a surface is tangent to a single plane. The more surface area in the sample the better. The fact that powdered materials have been used successfully may be explained by the fact that the total combined surface area in a powder is very large, constituting many planes available for the interaction. Use of powders made of the selected materials is also indicated by the fact that the absorption of deuterons is much easier using them Each small particle in a powder is more likely to contain a dominant, properly oriented, single crystal, or have a favorable shape, for the disclosed interaction to be established.
3. The same reasoning may be applied to materials that have been shaped into long filaments, and there is ample evidence that this has been successful. This evidence is apparent in relevant literature in this field of technology.
4. Electric stress may be applied in many ways, but an effective way is to shape the material such that it has sharp points, e.g., as in cone shapes. There is a well known concentration of electric charges near points, such as the points of cones, when these objects are immersed in an electric field. The planes perpendicular to the gradients in electric field and electric charge are then distinguished from their two perpendicular cohorts, breaking the three-fold symmetry.
5. Electronic properties of the materials of interest vary with temperature and deuteron concentration, and are not well known. Superconductivity at low temperatures and existence of ferromagnetic and anti-ferromagnetic phases are indicators of effective responses to both electric and magnetic fields, primarily magnetic fields. A uniform magnetic field breaks the three-fold symmetry properly as described in item 4, and acts strongly on any of the magnetic phases.
6. In other embodiments, magnetic fields may be used to induce the de Hass-van Alphen effect. This is an effect in which the magnetic susceptibility of the material varies periodically as an applied magnetic field is increased. The effect may be caused by the discrete energy levels of closed orbits of electrons in a partially filled conduction band. As the field changes, the Fermi energy level alternately falls within or without these levels (Peierls, 1955 and Ziman, 1965). As may be seen in FIG. 143 of Ziman (1965), the closed electron orbits may be on or near the Brillouin zone boundaries, on the wave length scale just where an interaction effect is required to excite the very short wavelength deuteron vibration. The de Hass-van Alphen effect couples with the electron charge distribution at these length scales, and this in turn couples to the interaction of the electrons and the lattice. This effect offers a good opportunity to initiate the low temperature fusion effect.
7. A time varying magnetic field may be added to the magnetic field inducing the de Hass-van Alphen effect in No. 6 above to aid in the excitation of the desired vibration modes. One method of doing this is to place the metal hydride in a resonant electromagnetic cavity at the region of the cavity's strongest field excitation. In this example, the cavity may be placed in a uniform magnetic field to achieve the conditions for the de Haas-van Alphen effect in the presence of these strong field excitations in the cavity.
8. A uniformly applied mechanical stress may break the crystal symmetry properly, while a non-uniform stress applied to a polycrystalline sample may break the symmetry differently in different portions of the sample. It is known that uniform stress may alter symmetry. Allied with this kind of symmetry breaking is that associated with dislocations and thermal annealing.
9. Another embodiment to apply an alternating stress is by means of acoustics. As an example, recent developments have allowed the use of lasers to generate very short powerful and controlled acoustic waves in materials (Feuer, 2003). Generating excitations acoustically is one way to enhance the desired lattice excitations. Excitations may also be generated using infrared interactions via Raman scattering.
10. There are many examples in materials research in which super-lattice materials have been constructed. A super-lattice is a crystal structure which has a lattice regularity larger than that of a normally structured crystal. The super-lattice periodicity is on a larger scale. Where a normal material has a basic set of atoms in its unit-cell with this cell repeated evenly throughout, a super-lattice has a unit-cell that repeats at intervals larger by an integer multiple. The large cell has regular substitutions made in the basic atomic set by other atoms. By substituting other atoms, a crystalline material may be constructed with the proper layered symmetry with a single parallel set of planes. Silver atoms, for example, may be placed in layers parallel to one of the planes of deuterons in titanium. The dynamic localization effect may cause a screening effect for the deuterons, may be found to occur stronger in super lattices (Dunlap and Kenkre (1986)). A method of exciting the dynamic localization effect has been described in Ghosh, Kuznetsov, and Wilkins (1997).
11. Electronegative or electropositive atoms may be selected for substitution (also known as doping) depending on whether more or fewer electrons are wanted in order to vary the Fermi energy level within a conduction band in the material. The doped material may easily transform from an electrical conductor to a (Mott) insulator depending on whether the d-band is less than or greater than half full, e.g., whether the Fermi level is toward the bottom or the top of the band. The state of the band is important relative to application of the de Hass-van Alphen effect in No. 6 above, and No. 12 below, as an example.
12. The atoms for substitution (in Nos. 10 and 11 above) may be selected so that the d-band is not filled. For example, it may be selected to place the Fermi level at the proper place in the d-band such at the wavelengths that correspond to the boundaries on the smaller Brillouin zones produce an effect comparable to a periodic Peirels instability. The Brillouin zones are smaller in a super lattice because the spatial periodicity is larger. Even if a periodic instability is not induced the static instability may be used to aid in the three-fold to single plane (3-D to 2-D) symmetry breaking.

Based on the low temperature fusion mechanism disclosed, cold fusion may be expected in any of the many high temperature superconductors. This is an important part of this disclosure. Materials other than metals that may be used for low temperature fusion include, without limitation, CeCu₂Si₂, UBe₁₃, UPt₃, URu₂Si₂, UPd₂Al₃, UNi₂Al₃, CeCu₂Ge₂, CeRh₂Si₂, CePd₂Si₂, and CeIn₃. Compounds that include the doped lanthanide copper oxides, the yttrium-barium-copper oxides, those with the generic composition RBa₂Cu₃O₇₋ₓ in which R stands for yttrium or one of the lanthanide rare earths, and the many others in the copper oxide family may also be used. The embodiment states that fusion of deuterons may be expected in any of these heavy electron systems if they contain absorbed deuterons.

13. These are heavy-quasi-particle materials with powerful electron correlation and magnetic interaction. Of these and others, the obvious candidates are those with an affinity for hydrogen and those possessing a layered structure (particularly with planar layers) into which the hydrogen atoms may fit. The materials listed are in many cases those whose heavy-electron properties are due to Kondo screening effects and f-electrons rather than the Hubbard model and d-electrons discussed elsewhere.
14. Akin to the de Haas-van Alphen effect is the Shubnikov-de Haas effect. It is demonstrated by a periodic variation of electrical resistivity with increasing magnetic field. It may also be used to initiate the desired crystal vibration modes, in a manner as described in No. 6 above.

Additionally, the initiation of the effect described in this disclosure depends on lattice motions in a plane in which deuterons are converging toward one another. Methods for initiating these elementary lattice motions, phonons, in parallel layers in the lattice, indicated for the production of the deuteron convergence effect consist of the following two items.

15. In one embodiment, optical radiation in the near infrared range with various polarizations may be used. The frequencies that may be used for deuteron vibration modes are in the 40 THz range. The optical wavelength at these frequencies may be of the order of 7.5 μM, and the separation between parallel plane layers may be of the order of 0.0002 μM, about 2 Angstroms. This discrepancy in wavelengths is not as important as the matching of frequencies. If the radiation is directed nearly perpendicular to the layered planes of deuterons, there may be a scattering of phonons into the plane caused by the interaction of the radiation with the lattice.
16. In another embodiment, a similar effect may be accomplished using Raman scattering with higher frequency radiation (>40 THz).

The effective-mass of the electrons in the transition metal may also be dependent on the location of the Fermi surface within the d-band. Further, the location of the Fermi level may be very important for the exploitation of the de Haas-van Alphen magnetic breakdown phenomena as described above described in item 6. In one embodiment, the breakdown effect may be used for exciting the appropriate lattice excitations. Methods for varying the number of electrons, and thus the Fermi energy and its location relative to the d-band are:
i. Dissimilar metal interfaces may be used in alternation. Due to the differing Fermi surface levels when different metals are brought in contact with one another, a boundary layer may be produced in the contact region wherein the energy bands vary continuously with respect to the Fermi energy within the layer.
ii. Further, an applied electrical field to generate a space charge effect may be used. This may be similar to item (i) such that in either case, there is a boundary layer with properties varying relative to the Fermi energy within which the optimal situation for use in the deuteron convergence effect or for the exploitation of the de Haas-van Alphen effect, can be made to arise. These boundary layers may be planar in conformation, thus breaking the three-fold symmetry.
iii. Another embodiment includes forming the metal into a conical shape with a sharp point and with it embedded in an intense electrical field in order to exploit the fact that the electrical charge is concentrated toward the point and varies significantly in the space around the point.
iv. Similar to item (i), layers of materials different from metals such as insulators or semiconductors may be used.
v. Alternatively, layered materials may be used where metal layers are separated by layers of insulating material.

Experimental Confirmation

A limited number of experiments have been performed, and more are planned. As noted herein, multiple deuterons or tritons in fusion reactions are expected to produce alpha particles. As known in the art, alpha particles are easily absorbed in air and much more so in water. For example, a 1 Mev alpha particle can be absorbed in less than one centimeter of air. It may be because the alpha particle can be absorbed prior to detection, and thus, nuclear products were not found in abundance in earlier low-temperature fusion experiments. This is especially true because the expectations of the experiments were for neutrons, protons, and gamma particle detections. The lack of the other particles in those experiments is actually a confirmation of the embodiments stated herein in the sense that if any nuclear process occurs, it must necessarily involve the production of alphas.

When alpha particles are absorbed, they become helium atoms. If helium atoms are produced where they didn't exist before, there must have been a nuclear reaction of some form. Professor J. J. Lagowski, at University of Texas, Austin, and colleagues measured the amount of helium gas produced during an electrolysis of palladium in a heavy water medium (Miles, Bush, Ostrom and Lagowski (1991)). They also measured the amount of excess heat. They were able to closely correlate the helium and heat production under the assumption that deuterons fused to form alpha particles with the well known amounts of energy release. This is confirmation of the embodiments of this disclosure in so far as nuclear reactions are concerned.

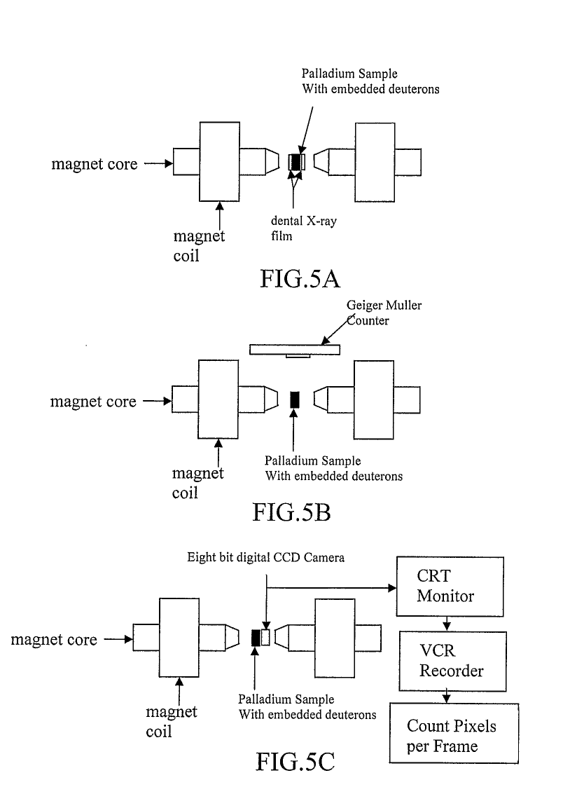

Referring to FIGS. 5A-5C, schematics of experiment setups are shown. In FIG. 5A, a large electromagnet is shown with the experimental specimen between the two poles. In this figure, the specimen consisted of a palladium bar that had been electrolyzed in heavy water to embed deuterons in the metal lattice. A foil of dental x-ray film was placed on either side of the palladium and the result was enclosed in a light retardant covering to prevent exposure of the film. The magnetic field was continuously varied between zero and 1.4 Tesla for a period of about eighteen hours. The film was developed to see if there was any exposure to gamma or alpha radiation. The results of the film are shown in FIG. 6.

Ingot 600 of FIG. 6 is the palladium ingot that was used, comprising rough grooves. The ingot was used as the cathode in an electrolysis cell using deuterium oxide with a small amount (approximately 0.2 gram per 100 milliliter) of lithium oxide to enhance the current flow. The electrolysis was performed over a period of about eighteen hours. The ingot then became the specimen for the experiment shown in FIG. 6. After exposure to the time-varying magnetic field, dental film 602 shown in the lower portion of FIG. 6 was obtained upon photo-development. As shown in FIG. 6, dental film 602 includes streaks that correspond to the grooves in the ingot 600. It is an attested fact that in many previous experiments, fusion appears to occur first at surface discontinuities. Prof. Lagowski and colleagues (Miles, Bush, Ostrom, Lagowski (1991)) found exposures of x-ray film in their electrolysis experiments as well as in experiments performed in Navy laboratories (Szpak, Mosier-Boss, Smith (1991)). The fact that this new experiment has found radioactivity in a specimen exposed to a magnetic field (and outside of an electrolysis cell) is an indication of the validity of certain embodiments described herein in which a field is recommended to lower the crystalline symmetry of the electrons and deuterons in the deuteron embedded metal to the two dimensional symmetry.

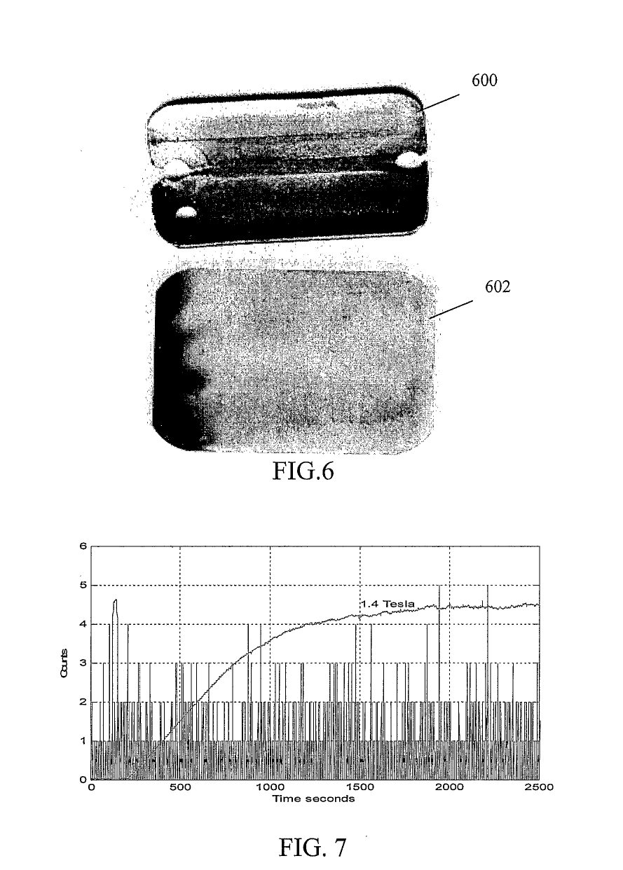

Referring to FIG. 5B, a large electromagnet is shown with another experimental arrangement between the two poles. The specimen again includes the palladium bar embedded with deuterons. The detector in this setup was a Geiger-Muller counter shown in relation to the magnet poles. The object in this case was again the detection of radiation produced in the palladium. The magnet was gradually increased in field strength as shown in FIG. 7. The resulting count of the detected events, e.g., radioactivities, was proportional to the heights of the vertical lines. The abscissa was time. As can clearly be seen from FIG. 7, there is an increase in the number of large counts as the field is increased. On other occasions, the correlation was not as clear.

Access to a much larger magnetic field is required to reach the de Haas-van Alphen effect in palladium. It is expected that definitive results will be found when such access is available. A difficulty in measuring emitted radiation by use of a Geiger counter was found to be that a Geiger-Muller tube cannot be used in a high magnetic field. To counter this difficulty, a new method of radiation monitoring was developed. The setup is shown in FIG. 5C. A readily available CCD camera is used to register charged particles by inducing charge on one or more of the pixels in the CCD, where a gamma is expected to accomplish this using the photo-electric effect. The multiple frames from the camera are recorded on a VCR (or other recording device known in the art) where they may be counted, frame-by-frame, by means of specialized software. The result is a device that registers bright spots similar to the phosphor scintillation counters of the early twentieth century but without the need for manual counting. The CCD camera has been shown to work effectively in a magnetic field. This device is being further refined for use in future experiments.

All of the methods disclosed and claimed herein can be made and executed without undue experimentation in light of the present disclosure. While the compositions and methods of this invention have been described in terms of preferred embodiments, it will be apparent to those of skill in the art that variations may be applied to the methods and in the steps or in the sequence of steps of the method described herein without departing from the concept, spirit and scope of the invention. More specifically, it will be apparent that certain compositions which are chemically related may be substituted for the compositions described herein while the same or similar results would be achieved. All such similar substitutes and modifications apparent to those skilled in the art are deemed to be within the spirit, scope, and concept of the invention as defined by the appended claims.

### REFERENCES

Each of the following references is hereby incorporated by reference in its entirety:
Abrikosov et al., In: Methods of Quantum Field Theory In Statistical Physics, Dover Publications, Inc., NY, 1975.
Dunlap and Kenkre, Phys. Rev., B Condens. Mat., 34(6):3625-3633, 1986.
Elsasser et al., Phys. Rev., B Condens. Mat., 44(18)::10377-10380, 1991.
Elsasser et al., Phys. Rev., B Condens. Mat., 50(8):5155-5159, 1994.
Feurer et al., Science, 299:374, 2003.
Fleischmann et al., Elecroanalyt. Chem., 261:301-308, 1989.
Franz, Science, 305(5689):1410-1411, 2004.
Ghosh et al., Phys. Rev. Ltrs., 79:3494, 1997.
Herzberg, In: Atomic Spectra and Atomic Structure, Dover Publications, NY, 1945.
Hora et al., Phys. Letters, A175:138, 1993.
Huizenga, In: Cold Fusion, The Scientific Fiasco of the Century, Oxford University Press, Oxford, 36-37, 1993.
Jones et al., Nature, 338:737, 1989.
Kadanoff and Baym, In: Quantum Statistical Mechanics, W. A. Benjamin Inc., NY, 1962.
Kittel, In: Introduction To Solid State Physics, John Wiley & Sons, NY, 259, 1961.
Koonin and Nauenberg, Nature, 339:690-691, 1989.
Legget and Baym, Nature, 340:45, 1989a.
Legget and Baym, Phys. Rev. Lett., 63:191, 1989b.
Miles et al., In: Science of Cold Fusion, Conf. Proceedings, Bologna, 1991.
Montorsi et al., In: The Hubbard Model, Chap. 4.3, FIG. 3, World Scientific, Singapore, 1992.
Montorsi, In: The Hubbard Model, A Reprint Volume, World Scientific, Singapore, 1992.
Parmenter and Lamb, Proc. Natl. Acad. Sci. USA, 86:8614; 87:8652, 1990.
PCT Application No. WO 2004/044923
Peierls, In: Quantum Theory of Solids, Oxford University Press, Oxford, 108-112, 1955.
Rasetti, In: The Hubbard Model, Recent Results, World Scientific, Singapore, 1991.
Rickayzen, In: Green's Functions and Condensed Matter, Academic Press, NY, 1980.
Shen, et al., Science, 307:901, 2005.
Slater, In: Symmetry And Energy Bands In Crystals, Dover Publications, NY, 1972.
Sulem and Sulem, In: The Nonlinear Schrodinger Equation, Springer-Verlag, Berlin, N.Y., 1999.
Szpak et al., J. Electronal. Chem., 302, 1991.
Tajima et al., Fusion Energy, 9:437, 1990.
Takahashi, In: Mechanism Of Deuteron Cluster Fusion By EQPET Model, 10^{th} Intl. Conf. on Cold Fusion, Cambridge, Mass., 2003.
Wipf, In: Diffusion of Hydrogen in Metals, Chap. III, Springer-Verlag, Berlin, N.Y., 1997.
Ziman, In: Principles of the Theory of Solids, Cambridge University Press, 1965.
Zwicknagl, Adv. Phys., 41:203-302, 1992.

1. A method for low-temperature fusion, comprising:
selecting a crystal lattice comprising a plurality of negatively charged high-effective mass electrons and embedded or absorbed deuterons;
initiating a vibration mode of the deuterons in a set of parallel planes, in which subsets of four deuterons are converging toward one another; and
enhancing a convergence of the deuterons by electrical screening using the negatively charged high-effective mass electrons grouped in a region of convergence of the deuterons, whereby an electron grouping effect is enhanced by a high-effective mass property of the crystal; and
allowing the deuterons to converge to one another to cause a nuclear fusion.

2. The method of claim 1, the charged high-effective mass electrons comprising electron pseudo particles.

3. The method of claim 1, the step of initiating the vibration mode further comprising initiating the vibration mode in a set of planar layers in the crystal lattice.

4. The method of claim 3, where initiating the vibration mode in a set of planar layers comprises shaping the lattice containing the embedded deuterons.

5. The method of claim 4, where shaping the lattice containing the embedded deuterons comprises shaping the lattice containing the embedded deuterons into thin films in which the two dimensionality of the shaped lattice is apparent.

6. The method of claim 4, where shaping the lattice containing the embedded deuterons further comprises forming a powder substance from the crystal lattice.

7. The method of claim 4, where shaping the lattice containing the embedded deuterons further comprises forming a sponge material comprising a plurality of holes.

8. The method of claim 4, where shaping the lattice containing the embedded deuterons comprises shaping the lattice containing the embedded deuterons in the form of a filament having a large surface area.

9. The method of claim 4, where shaping the lattice containing the embedded deuterons comprises shaping the lattice containing the embedded deuterons with a plurality of sharp points.

10. The method of claim 3, where initiating the vibration mode in a set of planar layers comprises applying one-dimensional fields to the lattice containing the embedded deuterons.

11. The method of claim 10, where the step of applying comprises applying an approximately uniform magnetic field or electrical field to the lattice containing the embedded deuterons.

12. The method of claim 10, where the step of applying comprises applying an approximately uniform mechanical stress field to the lattice containing the embedded deuterons.

13. The method of claim 3, where initiating the vibration mode in a set of planar layers comprises forming planar layers of the lattice containing the embedded deuterons.

14. The method of claim 13, where forming planar layers comprises in substituting in a super-lattice.

15. The method of claim 13, where forming planar layers comprises using layers of dissimilar metal interfaces, where at least one layer comprises metal hydride.

16. The method of claim 15, further comprising using layers of metal hydride alternating with layers of insulating or semiconducting materials.

17. The method of claim 13, where forming planar layers comprises using layers having differing doping properties.

18. The method of claim 13, where forming planar layers comprises using layers having a form of a single crystal super-lattice.

19. The method of claim 1, where initiating a vibration mode of deuterons comprises initiating a vibration mode in a set of parallel planes by use of external influences.

20. The method of claim 19, where the external influences comprise a magnetic field.

21. The method of claim 19, where the external influences comprise a de Haas-van Alphen effect or a Shubnikov-de Haas effect with a Fermi surface approximately half full and near a Brillouin boundary.

22. The method of claim 19, where the external influences comprise a Ziman's magnetic breakthrough effect.

23. The method of claim 1, where initiating the vibration mode comprises applying plane wave acoustics perpendicular to and/or parallel to a vibration plane.

24. The method of claim 1, initiating the vibration mode comprises applying infrared radiation perpendicular or parallel to the vibration plane,

25. The method of claim 24, where applying infrared radiation comprises generating the infrared radiation by a laser.

26. The method of claim 25, the laser comprising a free electron laser.

27. The method of claim 24, where applying infrared radiation comprises using Raman scattering.

28. The method of claim 1, further comprising varying a location of a Fermi surface in the crystal.

29. The method of claim 28, the step of varying a location comprising using a space charge effect at a contact point of two dissimilar metals of the lattice containing the deuterons to vary an electron concentration.

30. The method of claim 28, the step of varying a location comprising applying an electric field to the lattice to produce a space charge effect in a layer in which the relative Fermi surface is varying.

31. The method of claim 28, further comprising substituting electropositive or electronegative atoms into a metal hydride matrix to change the concentration of electrons.

32. The method of claim 1, where the region of convergence comprises a tetrahedron, and where the deuterons converge from the corners to the center of the tetrahedron.

33. A method comprising:
providing a specimen comprising embedded deuterons;
providing an x-ray film coupled to the specimen;
exposing the film to an electromagnetic field;
developing the film; and
determining the affect of the electromagnetic field on the film.

34. The method of claim 33, the specimen comprising a palladium bar.

35. The method of claim 34, further comprising electrolyzing the palladium bar in heavy water to embed the deuterons.

36. The method of claim 33, where exposing the film to an electromagnetic field comprises varying the electromagnetic field between zero and about 1.4 Tesla.

37. A method comprising:
selecting a heavy electron material;
embedding deuterons in the heavy-electron material; and
initiating a convergence of the deuterons by applying a vibration mode to a set of parallel planes of the heavy electron material.

38. The method of claim 37, the heavy electron material comprising a heavy metal, CeCu₂Si₂, UBe₁₃, UPt₃, URu₂Si₂, UPd₂Al₃, UNi₂Al₃, CeCu₂Ge₂, CeRh₂Si₂, CePd₂Si₂, and CeIn₃.
